(19) United States
(12) Patent Application Publication
(10) Pub. No.: US 2019/0265378 A1
(43) Pub. Date: Aug. 29, 2019

(54) AUTOMATED OCEAN BOTTOM SEISMIC NODE IDENTIFICATION, TRACKING, DEPLOYMENT, AND RECOVERY SYSTEM AND METHOD

(71) Applicant: Seabed Geosolutions B.V., Leidschendam (NL)

(72) Inventors: Michael Meech, Houston, TX (US); Martin John Hartland, Katy, TX (US); Nishan Ragoonanan, Houston, TX (US); Adam Bialowas, Houston, TX (US)

(73) Assignee: Seabed Geosolutions B.V., Leidschendam (NL)

(21) Appl. No.: 16/282,889

(22) Filed: Feb. 22, 2019

Related U.S. Application Data
(60) Provisional application No. 62/634,421, filed on Feb. 23, 2018.

(51) Int. Cl. G01V 1/38

(52) U.S. Cl. CPC G01V 1/3835; G01V 1/3852

(57) ABSTRACT

A system, apparatus, and method for individually identifying, handling, tracking, deploying, and recovering a plurality of seismic nodes by an underwater vehicle for subsea operations. The deployment and positioning and retrieval of seismic nodes to and from the seabed may be managed automatically by software and/or manually automated by an ROV operator. The disclosed system may be coupled to a ROV navigation system. The node identification system tracks the position of each seismic node (associated with a unique identification number) within each tray or other node holder at all times, whether the tray is located on board a surface vessel, within an ROV, within a subsea basket, or on the seabed. The identification system is configured to track, select, deploy, and recover a particular seismic node by its unique identification number.

### PRIORITY

This application claims priority to U.S. provisional patent application No. 62/634,421, filed on Feb. 23, 2018, the entire content of which is incorporated herein by reference.

### BACKGROUND OF THE INVENTION

### Field of the Invention

This invention relates to the deployment and recovery of seismic nodes by an underwater vehicle, and more particularly relates to the identification, tracking, deployment, and recovery of ocean bottom seismic nodes during subsea operations.

### Description of the Related Art

Marine seismic data acquisition and processing generates a profile (image) of a geophysical structure under the seafloor. Reflection seismology is a method of geophysical exploration to determine the properties of the Earth's subsurface, which is especially helpful in determining an accurate location of oil and gas reservoirs or any targeted features. Marine reflection seismology is based on using a controlled source of energy (typically acoustic energy) that sends the energy through seawater and subsurface geologic formations. The transmitted acoustic energy propagates downwardly through the subsurface as acoustic waves, also referred to as seismic waves or signals. By measuring the time it takes for the reflections or refractions to come back to seismic receivers (also known as seismic data recorders or nodes), it is possible to evaluate the depth of features causing such reflections. These features may be associated with subterranean hydrocarbon deposits or other geological structures of interest.

In general, either ocean bottom cables (OBC) or ocean bottom nodes (OBN) are placed on the seabed. For OBC systems, a cable is placed on the seabed by a surface vessel and may include a large number of seismic sensors, typically connected every 25 or 50 meters into the cable. The cable provides support to the sensors, and acts as a transmission medium for power to the sensors and data received from the sensors. One such commercial system is offered by Sercel under the name SeaRay®. Regarding OBN systems, and as compared to seismic streamers and OBC systems, OBN systems have nodes that are discrete, autonomous units (no direct connection to other nodes or to the marine vessel) where data is stored and recorded during a seismic survey. One such OBN system is offered by the Applicant under the name MANTA®. For OBN systems, seismic data recorders are placed directly on the ocean bottom by a variety of mechanisms, including by the use of one or more of Autonomous Underwater Vehicles (AUVs), Remotely Operated Vehicles (ROVs), by dropping or diving from a surface or subsurface vessel, or by attaching autonomous nodes to a cable that is deployed behind a marine vessel.

Autonomous ocean bottom nodes are independent seismometers, and in a typical application they may be self-contained units comprising a housing, frame, skeleton, or shell that includes various internal components such as geophone and hydrophone sensors, a data recording unit, a reference clock for time synchronization, and a power source. The power sources are typically battery-powered, and in some instances the batteries are rechargeable. In operation, the nodes remain on the seafloor for an extended period of time. Once the data recorders are retrieved, the data is downloaded and batteries may be replaced or recharged in preparation of the next deployment. Various designs of ocean bottom autonomous nodes are well known in the art. See, e.g., U.S. Pat. No. 9,523,780 (citing patents and publications), incorporated herein by reference. Still further, the autonomous seismic node may be integrated with an AUV such that the AUV, at some point subsea, may either travel to or from the seabed at a predetermined position. See, e.g., U.S. Pat. No. 9,090,319, incorporated herein by reference. In general, the basic structure and operation of an autonomous seismic node is well known to those of ordinary skill.

Marine seismic surveys need a fast and cost-effective system for deploying and recovering autonomous seismic receivers that are configured to operate underwater. One conventional method (as illustrated in FIG. 1) is to deploy a ROV in a body of water while also deploying a separate underwater node transfer device, such as a basket, that is configured to hold a plurality of seismic nodes and be lowered and raised from a surface vessel. At a certain subsea position, the ROV docks or mates with the node transfer device and transfers one or more nodes from the node transfer device to the ROV. The ROV then places the retrieved nodes at one or more positions on the seabed. Prior art patents and publications illustrating this option include at least the following: U.S. Pat. Nos. 6,975,560; 7,210,556; 7,324,406; 7,632,043; 8,310,899; 8,611,181; 9,415,848; 9,873,496, and U.S. Patent Application Publication Nos. 2006/0159524 and 2015/0284060, each of which is incorporated herein by reference. Still further, prior art patents also disclose the touch down monitoring of an ocean bottom seismic node by an autonomous underwater vehicle (AUV). See, e.g., US. Pat. No. 9,891,333.

The prior art systems for identifying, handling, and deploying seismic nodes from an underwater basket and/or underwater vehicle are problematic. They generally fail to individually identify, manage, handle, and/or deploy seismic nodes. Such systems are not automated, costly, and slow.

A need exists for an improved method and system for deploying and recovering ocean bottom seismic nodes to and from the seabed from an underwater vehicle. A need exists for an improved seismic node identification and tracking system.

### SUMMARY OF THE INVENTION

A system, apparatus, and method for individually identifying, handling, tracking, deploying and recovering a plurality of seismic nodes by an underwater vehicle for subsea operations. The deployment and positioning and retrieval of seismic nodes to and from the seabed may be managed automatically by software and/or manually automated by an ROV operator. The disclosed system may be coupled to a ROV navigation system. The identification system is configured to know the position of each seismic node (associated with a unique identification number) within each tray or other node holder at all times, whether the tray is located on board a surface vessel, within an ROV, within a subsea basket, or on the seabed. The identification system is configured to track, select, deploy, and recover a particular seismic node by its unique identification number. The method and system may include automatically positioning the underwater vehicle based on automated guidance from a navigation system. The automated guidance may include generating step by step procedures for deploying and retrieving each of the seismic nodes on the seabed, traveling between different subsea positions for such deployment, and transferring seismic nodes between a subsea basket and an underwater vehicle.

In one embodiment, disclosed is a method for automatic identification of ocean bottom seismic nodes, comprising automatically identifying a unique identification number for each of a plurality of seismic nodes, positioning the plurality of seismic nodes on a node platform at a plurality of node positions within the node platform, and automatically recording each of the unique identification numbers for each of the plurality of node positions. The method may further include automatically tracking the position of each of the plurality of seismic nodes within the node platform based on the unique identification number of each of the plurality of seismic nodes. The unique identification number for each seismic node may comprise a RFID tag or a visible marker on the node.

The identification method may further comprise loading the plurality of seismic nodes on the node platform based on the unique identification number of each of the plurality of seismic nodes. The method may further comprise automatically the plurality of seismic nodes from the node platform based on the unique identification number of each of the plurality of seismic nodes. The method may further comprise selecting one of the plurality of seismic nodes for transfer from the node platform based on the unique identification number of each of the plurality of seismic nodes. The method may further comprise transferring the node platform with the plurality of seismic nodes onto a remotely operated vehicle. The method may further comprise deploying each of the plurality of seismic nodes on the seabed at a predetermined position by a remotely operated vehicle based on the unique identification number of each of the plurality of seismic nodes and automatically recording the touchdown position of each of the plurality of seismic nodes. One or more of these steps may be performed automatically with little to no ROV operator involvement.

In another embodiment, disclosed is a method for the deployment of a plurality of seismic nodes on or near the seabed, comprising positioning a remotely operated vehicle proximate to the seabed, wherein the underwater vehicle carries a plurality of seismic nodes, wherein each of the plurality of seismic nodes comprises a unique identification number, selecting one of the plurality of seismic nodes for deployment on the seabed, deploying the selected seismic node at a predetermined position on the seabed; determining a touchdown position of the node on the seabed; and recording the touchdown position of the node. One or more of these steps may be performed automatically with little to no ROV operator involvement. In one embodiment, the touchdown position comprises position coordinates, depth, and azimuth of the node. The deployment method may further comprise automatically associating the touchdown position of the node with the unique identification number of the node. The method may further comprise automatically tracking the position of each of the plurality of seismic nodes within the remotely operated vehicle based on the unique identification number for each of the plurality of seismic nodes. In one embodiment, the recording step may comprise taking a picture of the node on the seabed and the positioning step may be based on automated guidance from a navigation system. In one embodiment, the selecting step may be based on the unique identification number for each of the plurality of seismic nodes, while in another embodiment the selecting step may comprise selecting one of the plurality of seismic nodes by selecting a unique identification number.

In another embodiment, disclosed is a method for the recovery of a plurality of seismic nodes on or near the seabed, comprising positioning a remotely operated vehicle proximate to a plurality of positions on the seabed, wherein a seismic node is located at each of the plurality of seabed positions, wherein each of the plurality of seismic nodes comprises a unique identification number, recovering a plurality of seismic nodes from the seabed by the remotely operated vehicle, selecting one of the plurality of seismic nodes for recovery from the seabed based on a unique identification number of each of the plurality of seismic nodes, and identifying the unique identification number of each of the plurality of seismic nodes. One or more of these steps may be performed automatically with little to no ROV operator involvement. The recovery method may further comprise automatically tracking the position of each of the plurality of seismic nodes within the remotely operated vehicle. The method may further comprise positioning the plurality of seismic nodes on a node platform within the underwater vehicle at a plurality of node positions within the node platform. The method may further comprise automatically recording each of the unique identification numbers for each of the plurality of node positions. In one embodiment, the positioning step may be based on automated guidance from a navigation system.

In another embodiment, disclosed is a subsea node identification system for the deployment of a plurality of seismic nodes on the seabed. The system may comprise a node tracking system and a node deployment system. The node tracking system may be configured to automatically track the position of each of a plurality of seismic nodes within an underwater vehicle. The node touchdown system may be configured to record the touchdown position of each of the plurality of seismic nodes. The node touchdown system may be configured to identify the ID, position, depth, and azimuth of each seismic node upon touchdown with the seabed. The node deployment system may be configured to automatically select one of the plurality of seismic nodes for placement on the seabed at a predetermined position. The subsea identification system may be located on a ROV or coupled to a ROV navigational system. In one embodiment, each of the plurality of seismic nodes is located on a tray.

### BRIEF DESCRIPTION OF THE DRAWINGS

The following drawings form part of the present specification and are included to further demonstrate certain aspects of the present invention. The invention may be better understood by reference to one or more of these drawings in combination with the detailed description of specific embodiments presented herein.

FIG. 1 illustrates one embodiment of a deployment system from a marine vessel.

FIG. 2 illustrates one embodiment of a seismic node holder (e.g., a tray) carrying a plurality of seismic nodes.

FIG. 3 illustrates one embodiment of an automated guidance system display for a ROV in node deployment mode according to one embodiment of the present disclosure.

FIG. 4 illustrates one embodiment of an ROV navigation display according to one embodiment of the present disclosure.

FIG. 5 illustrates various deployment line embodiments of deploying seismic nodes on the seabed by an underwater vehicle.

FIG. 6. illustrates a schematic of an automated guidance system display for a ROV in node recovery mode according to one embodiment of the present disclosure.

FIG. 7 illustrates a topographical map of pre-defined seismic node positions on the seabed according to one embodiment of the present disclosure.

FIG. 8 illustrates one embodiment of a node information record according to one embodiment of the present disclosure.

### DETAILED DESCRIPTION

Various features and advantageous details are explained more fully with reference to the nonlimiting embodiments that are illustrated in the accompanying drawings and detailed in the following description. Descriptions of well-known starting materials, processing techniques, components, and equipment are omitted so as not to unnecessarily obscure the invention in detail. It should be understood, however, that the detailed description and the specific examples, while indicating embodiments of the invention, are given by way of illustration only, and not by way of limitation. Various substitutions, modifications, additions, and/or rearrangements within the spirit and/or scope of the underlying inventive concept will become apparent to those skilled in the art from this disclosure. The following detailed description does not limit the invention.

Reference throughout the specification to “one embodiment” or “an embodiment” means that a particular feature, structure, or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures, or characteristics may be combined in any suitable manner in one or more embodiments.

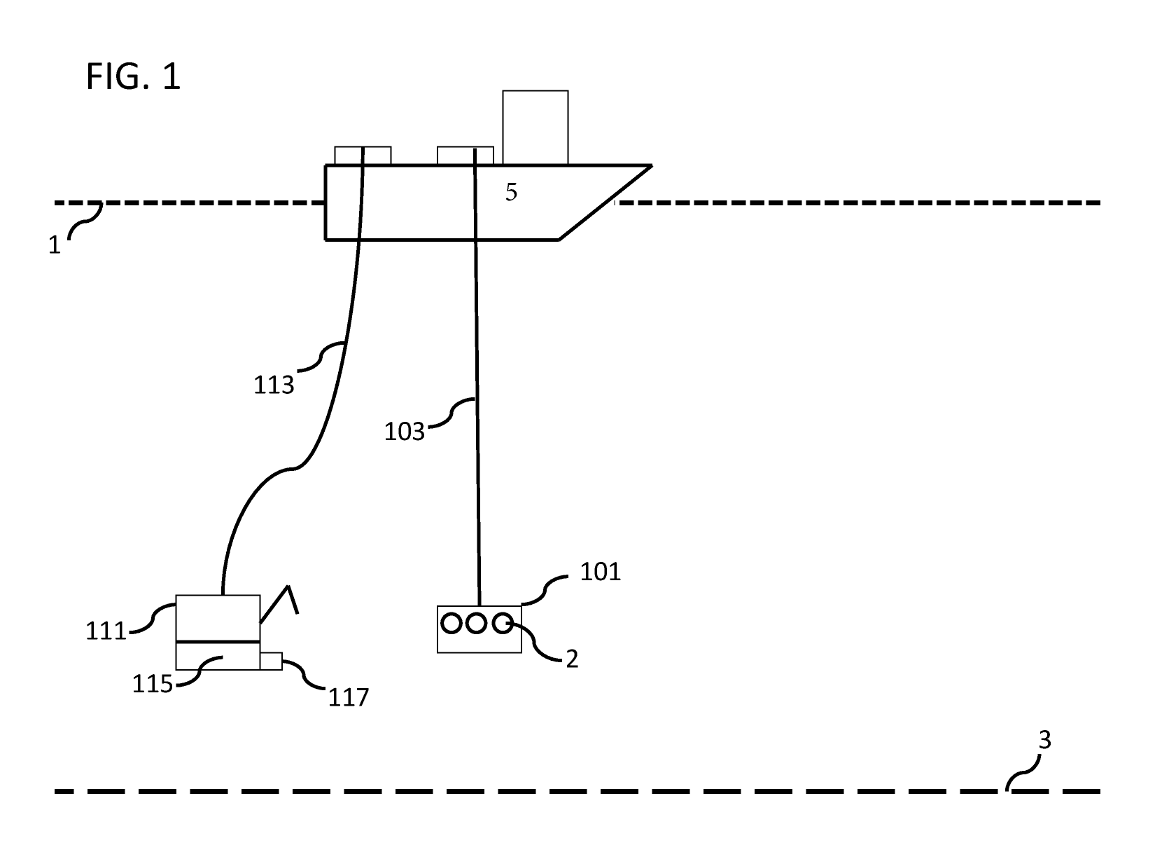

FIG. 1 shows one embodiment of the present disclosure. Seismic devices, such as autonomous seismic nodes, may be lowered from a marine surface vessel to a subsea position for transferring of those nodes to an unmanned underwater vehicle (UUV), such as a remotely operated vehicle (ROV), and placing on seabed 3. ROV 111 may be deployed from surface vessel 5 from the surface of a water body, such as sea surface 1. The ROV may be coupled to the surface vessel while in the water via deployment line 113, such as a tether, cable, wire, or rope, as is known in the art. Surface vessel 5 is shown in a simplified version in FIG. 1, and one of skill in the art will realize that many more components may be located on the back deck of the vessel for standard vessel operations. For example, one or more launch and recovery systems (LARS) may be located on the back deck of the vessel, which is used to deploy and recover the ROV. While not illustrated for simplicity purposes, for some types of subsea equipment (such as an ROV), deployment line 113 may consist of separate sections, such as a tether section and an umbilical section. For example, as is known in the art, if subsea equipment 111 is an ROV (such as the FUGRO FCV3000 or other similar ROV), the ROV is coupled to a tether management system (TMS) via a first wire segment (or tether) and the TMS is connected to the surface vessel via a second wire segment (such as an umbilical cable). In general, for the purposes of this disclosure, some or all of the portions of an ROV's tether and/or umbilical cable (or other similar subsea device) may be generally considered as the ROV's deployment line. In other embodiments, an autonomous underwater vehicle (AUV) or other UUV may be used instead of an ROV.

In one embodiment, the ROV may have a skid or other payload storage system 115 for storing one or more payload devices and/or for transferring such payload devices from a subsea basket 101 to ROV 111. For example, skid 115 may comprise or be coupled to docking system 117 for docking and/or coupling ROV 111 to subsea basket 101, which may or may not have a corresponding collar or docking mechanism to mate with the docking system of the ROV. Skid 115 may be located on an underside of the ROV (as shown in FIG. 1) and/or may be partially located on a front, back, or side portion of the ROV. In some embodiments, seismic nodes 2 may be stored and/or handled by a plurality of grabbers, grippers, manipulators, or other single node handling devices (including conveyors, trays, and other seismic transfer mechanisms), as described herein, which may be located within and/or coupled to skid 115.

Subsea equipment 101 may be lowered from surface vessel 101 via cable/line 103. Subsea equipment 101 may be a cage, basket, skid or any other transfer device capable of holding a plurality of payload units, such as a plurality of ocean bottom autonomous seismic nodes 2 in a body of water and transferring those nodes to an external device, such as ROV 111. Thus, in one embodiment, subsea device 101 is a node transfer device. At various operational stages device 101 may be located near the water surface, at a subsea position between the seabed and the surface, near the seabed, or on the seabed. In one embodiment, the ROV and/or node transfer device may be moving in the body of water with a speed based on movement of the subsea structure, movement of the vessel, and/or current movement. Thus, ROV 111 and subsea basket 101 may mate and/or couple at a position above the seabed while one or both devices are moving. In one embodiment, the ROV and the node transfer device each comprise acoustic modems that are configured to communicate with each other via acoustic communications.

While various ROVs and other subsea devices may be used with the embodiments presented in this disclosure, the present disclosure is not limited to any particular ROV, underwater vehicle, subsea transfer device, or configuration thereof to deploy the autonomous seismic nodes on the seabed. Similarly, while one application of the present disclosure is directed to ROVs and subsea baskets used for seismic node deployment in a body of water (such as ocean bottom seismic nodes placed on the seabed), the present disclosure is not limited to such an application or subsea transfer device, and is generally useful for any individual identification, handling, tracking, and deployment of any ocean bottom payload package.

For ocean bottom seismic nodes, it is important to identify the particular node placed at the particular seabed position for seismic data recording and processing. However, prior art techniques for node identification are slow and are not automated. The disclosed method and system is not dependent on a particular ROV, ROV skid, seismic node, node holder mechanism (e.g., tray), or even node deployment method.

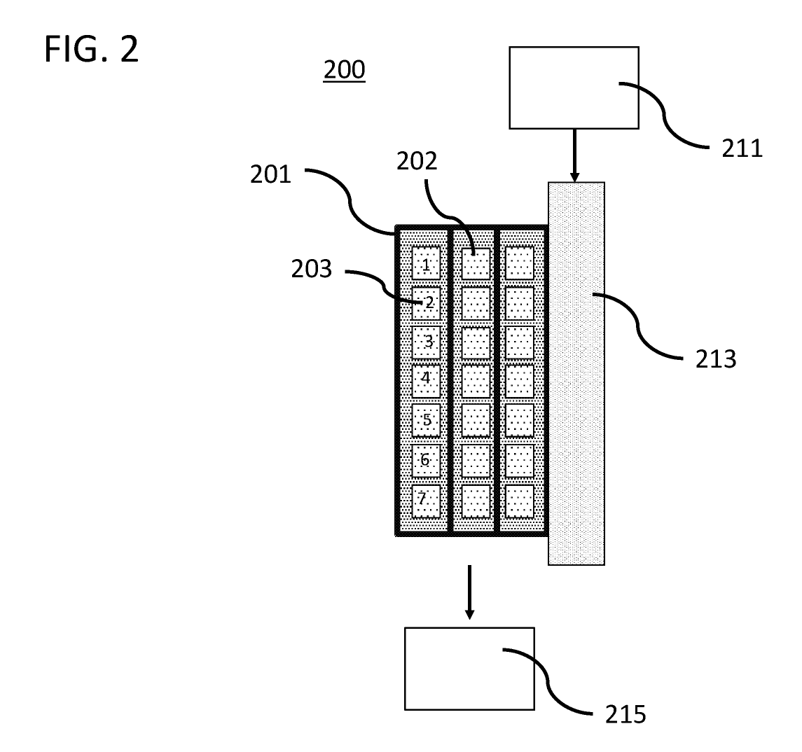

As is known in the art, seismic nodes may be loaded onto and/or carried by a tray or other node holding mechanism. FIG. 2 illustrates one embodiment of a tray loaded with seismic nodes. The tray may or may not be located on an ROV. For example, seismic nodes 202 may be stored on node storage system 211 (located on a surface vessel) and transferred to tray 201 via conveyor 213 or similar transfer mechanism. See, e.g., U.S. Pat. No. 9,459,366, incorporated herein by reference. The nodes may be transferred to the tray automatically or manually. Once the tray is loaded with seismic nodes, the tray may be manually or automatically transferred to subsea device 215, such as ROV 111 (and/or ROV skid 115) or subsea basket 101. The subsea device may be lowered into the water via conventional techniques with tray 201 loaded with seismic nodes.

The tray or other node platform 201 may comprise a plurality of shapes and configurations. In one embodiment, the tray is substantially rectangular and is configured to hold approximately 21 seismic nodes in three columns and with seven rows per column. Other arrangements are possible based on size of the node, tray, ROV, and/or subsea basket. In one embodiment, each position on the tray is identified by a number (such as number 203). For example, a first column on the tray may be identified by node positions 1-7, a second column on the tray may be identified by node positions 8-14, and a third column on the tray identified by node positions 15-21. In one embodiment, each seismic node has a visual tag or indicator on an exterior portion of the seismic node as well as one or more unique identification numbers that may be read by a radio frequency identification (RFID) reader or other wireless technique. In some embodiments, a tray may not be used, and the nodes may simply be arranged on one or more fixed or sliding horizontal guides, members, or rails as is known in the art.

In one embodiment, during transit of seismic nodes 202 from node storage system 211 to tray 201, the nodes are scanned by an RFID system whereby a unique identification may be recorded. The RFID system may be located on the ROV and/or the surface vessel. In one embodiment, each node may have multiple unique IDs, such as two RFIDS per node. The exact placement of the node within each tray, node holder, or platform (e.g., a specific row and column position) is recorded and provided to a centralized database system which records the composition of each tray of nodes (e.g., a specific node ID is associated with a specific node position for the specific tray). The database translates the RFID to the unique label that is displayed on each node and transmits this information for each tray of nodes to the utilized ROV navigation system. For example, if ten trays are utilized for the subsea operation, the database may record the unique ID for each node for each node position within each tray. At any point during the subsea operations, a particular tray may be selected to display the individual nodes within that tray. At all times, each position of a particular seismic node is known, whether the node is within a particular tray (and the unique node position within a tray) and whether the tray (and particular node) is on the surface vessel, particular ROV, subsea basket, or ocean floor. In one embodiment, each seabed position for the seismic survey has a predetermined node assigned to that position, and the trays are loaded with appropriate seismic nodes according to the particular node deployment routine. In other embodiments, a particular tray may be used multiple times within a survey with different seismic nodes. For these embodiments, the disclosed identification and tracking system separately records the different seismic nodes for each tray deployment/use. In one embodiment, an automated control system—which may be combined with the ROV navigation system—manages the operations of seismic node identification, handling, and placement. For example, for any particular operation, a particular tray may be selected by the ROV operator and the ID and position of seismic nodes on the corresponding tray displayed on a user interface. Such features allow real time knowledge of the position of all seismic nodes during a deployment operation and increased operational control of the deployment and recovery process of the seismic nodes.

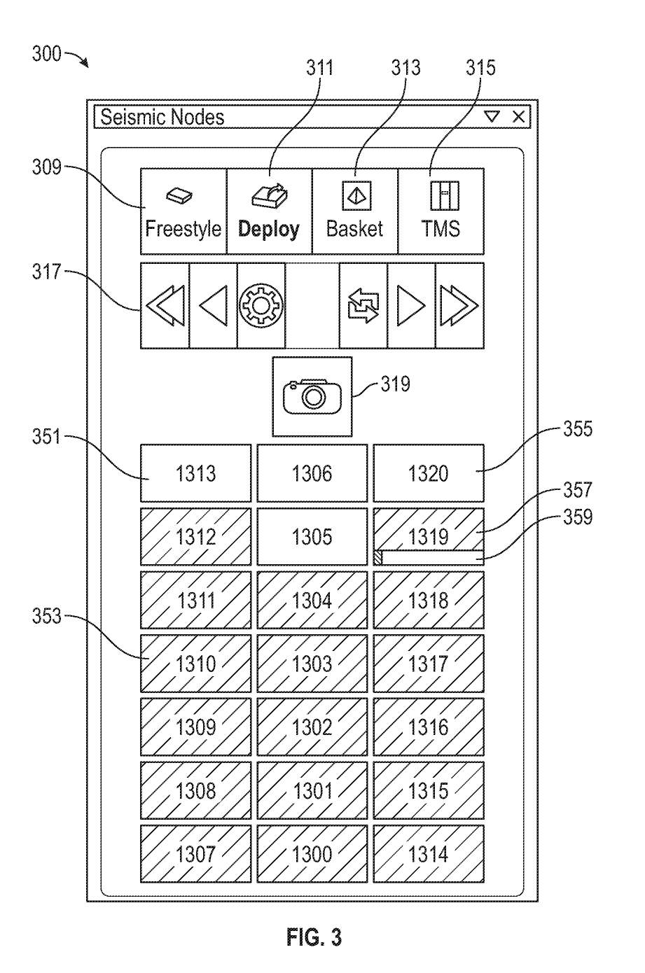

FIG. 3 shows one embodiment of a navigation display 300 of the present disclosure. Display 300 may be a touchscreen operated by the ROV operator and be accessible by the ROV operator while on the surface vessel or other remote location from the ROV. It may be part of and/or coupled to a ROV navigation system. In one embodiment, display 300 provides a user interface for subsea ROV operations and for selecting a seismic node to be deployed on and/or retrieved from the seabed. For example, on arrival to a particular subsea location the ROV operator may select a seismic node to be placed from the ROV to the seabed. In one embodiment, the seismic nodes are each positioned on the tray, and the desired node(s) are positioned relative to the ROV skid so that they can be grabbed and/or handled by an ROV manipulator arm (such as by a suction cup of the arm) during movement to or from the seabed or other subsea location. When the seismic node is placed on the seabed, the ROV operator may select the corresponding node which records the specific geographic position of the selected node and the corresponding ID and/or visual label on the seismic node. In some embodiments, a picture may be taken by the ROV of the node during touchdown which provides additional confirmation of the touchdown position of the seismic node. Such a position may be automatically inputted into the relevant database for the particular node. For the present disclosure, touchdown is the point of contact of a node to the seabed.

One embodiment of navigation display 300 is described herein in more detail. As mentioned above, navigation display 300 may be provided by and/or coupled to a ROV navigation system. A ROV navigation system may include automated and/or manual operations as is known in the art. In some embodiments, a particular button on display 300 causes a particular operation to be performed by the ROV and in other embodiments merely selects a different screen or program within the ROV navigation system. In one embodiment, button 309 is labelled “freestyle” and allows operations where the ROV is not in direct control by the automated guidance system and the operator can manually perform other tasks as required by the survey operation or task. Button 311 is labeled “deploy” and provides operator toggles between node deployment and node retrieval operations. Button 313 is labelled “basket” and provides automated guidance for ROV navigation back to the subsea basket. Button 315 is labelled “TMS” and provides automated ROV navigation guidance and piloting back to the TMS (Tether Management System), such as in situations where the surface vessel is conducting maneuvers from one node deployment line to another node deployment line. Row of buttons 317 allows configuration for guidance of the ROV along a line of nodes, allowing the operator to define which line of nodes to deploy. In this embodiment, the operator may direct in which direction to deploy the nodes and to advance to any starting point along that line. Button 319 allows a picture to be taken by the ROV and automatically associates the picture with the selected seismic node where it was deployed and/or where it was recovered.

In one embodiment, navigation display 300 identifies the unique node ID and/or visual tag for each node at each position within the tray. For example, node 1313 occupies the first row and column position 351 of the tray. Node 1310 is the fourth node in the first row, at position 353. Node position 355 has a “blank” background, indicating that the relevant node (node 1320) has already been deployed on the seabed. In contrast, nodes at node positions with hashmarks (e.g., node position 353/node 1310) have not been deployed yet. In one embodiment, the selection of each node on display 300 allows various information to be displayed for that node. In other embodiments, during seabed placement, the ROV operator may select a particular node, which automatically instructs the ROV to obtain that particular node and place it at the intended seabed position. Once the node is positioned on the seabed, the touchdown position may be automatically recorded (such as by a position fix and/or a picture) and associated with the particular seismic node in a database. In some embodiments, if a particular task is being performed for a particular node, progress bar 359 may be displayed that indicates the status of progress for that particular task for that particular node. For example, progress bar 359 displays the progress of a particular operation for node 1319, which may indicate that node 1319 is being deployed with the deployment step being less than halfway complete.

Once the desired node has been placed on the seabed, the ROV navigation system will automatically guide the ROV to the next seabed position where the next seismic node is to be placed. In one embodiment, each of the predetermined seabed node positions (which may be in the order of hundreds or thousands) has been determined and, based on the desired deployment system, a list of specific actions and/or steps has been generated to compose the most efficient deployment operation and/or scheme of the seismic nodes.

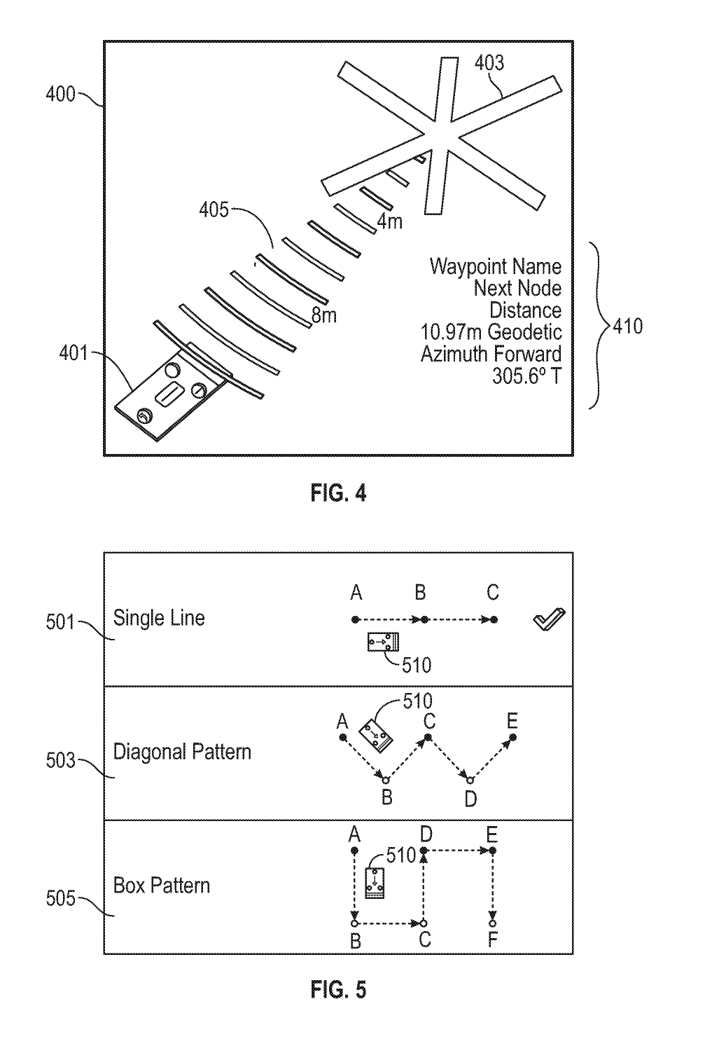

FIG. 4 illustrates one embodiment of ROV navigation display 400 generated by an automated guidance system for a ROV according to the present disclosure. FIG. 4 shows ROV 401 travelling towards intended destination 403, which is approximately 10 meters away from the ROV, via intended path 405. In one embodiment, real time navigation data 410 for the ROV may be displayed to the ROV operator. Navigation data 410 may include waypoint name, node position, distance, heading, direction, and temperature (among other items) for the ROV position and/or destination. This navigation data may be displayed to the ROV operator in real time based on active guidance and/or information provided by a ROV navigation system. In one embodiment, automated guidance (including distance and azimuth to travel) are calculated and provided to the ROV and/or ROV operator at all times by the ROV navigation system. In another embodiment, the automated guidance engages auto-pilot ROV enabling travel to the next node placement.

FIG. 5 illustrates various deployment line embodiments of deploying seismic nodes on the seabed by an underwater vehicle. In one embodiment, a single deployment line may be laid by the underwater vehicle (see path 501), or multiple deployment lines may be laid utilizing any number of patterns, such as serpentine, diagonal (path 503), and box (path 505) patterns. In one embodiment, ROV 510 moves between node seabed positions A-F in different paths depending on the most optimal path and node position design on the seabed. In one embodiment, the ROV is automated to travel a pre-selected path for the deployment of the nodes, while in other embodiments an operator may assist the ROV in each deployment step while the ROV automatically travels between the different subsea positions.

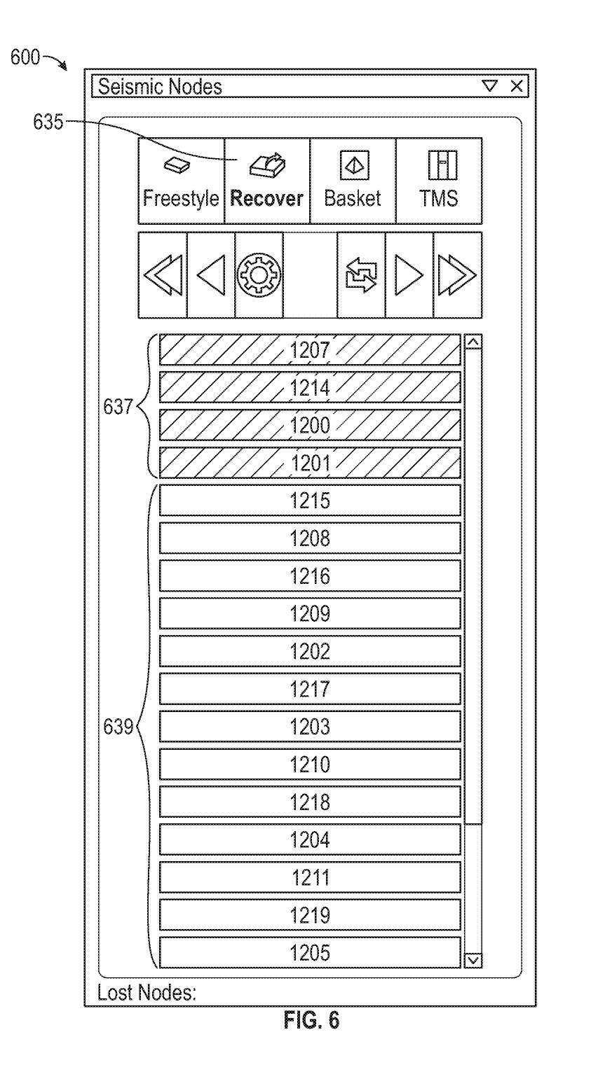

FIG. 6 illustrates another embodiment of navigation display 600 of the present disclosure. In one embodiment, navigation display 600 provides a user interface for recovery of nodes that have been placed on the seabed in a recovery mode (indicated by recover button 635). On arrival of the ROV to the location of the previously placed node, in one embodiment the ROV picks the node up from the seabed (via a manipulator arm) and places it on the ROV skid. In one embodiment, the geographic coordinates of the node including its identification, label and representation were determined at the time of placement and is provided to the ROV via a navigation system. When the node is picked up, the ROV operator may select the node which corresponds to the observed node and the corresponding ID and/or visual label on the seismic node and record the as found specific geographic position of the selected node (which may or may not be the same as the position in which the node was dropped off on the seabed). In one embodiment, navigation display 600 provides a list of seismic nodes by their unique identifications, and groups the nodes depending on whether they have already been recovered or if they still need to be recovered. For example, the node (such as nodes 1207, 1214, 1200, and 1201) may be marked as already “collected” by a particular background or color (indicated by “hashed” nodes in FIG. 6 in recovered group 637). In one embodiment, the exact order of the nodes that were deployed are presented to the operator in the order in which they are to be collected. For example, in FIG. 6, node 1207 was deployed first followed by nodes 1214, 1200, and 1201, etc. Nodes to be collected are marked with a different background, such as a “blank” background. For example, seismic nodes within “nodes to be recovered” group 639 are all “blank,” indicating that they have not yet been recovered. In one embodiment, the ROV automatically recovers the nodes in the order that they were deployed. In other embodiments, the user may select which particular node should be recovered in the desired order.

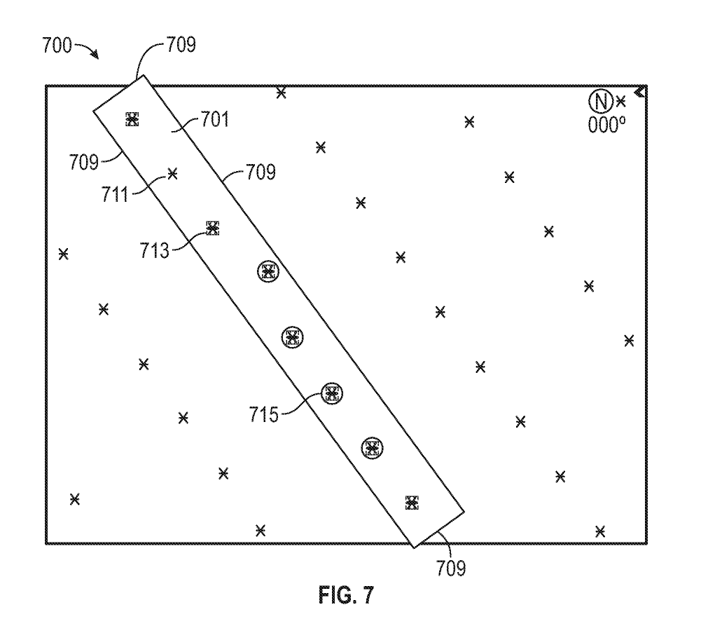

FIG. 7 illustrates one embodiment of survey map display 700 where the nodes to be deployed are represented to scale based on a geographic system organized into various geographic regions. In one embodiment, certain geographic regions are designated by geographic lines, which may correspond to an intended node deployment or recovery path. For example, geographic lines 709 may set the boundaries of a particular set of seabed positions on which nodes are being deployed within geographic region 701. The seismic nodes and/or seabed positions within geographic region 701 may be marked by different indicators to provide information on the operation as to that node position (e.g., whether nodes have been placed or not). In one embodiment, nodes to be placed are represented by a symbol that can be unique to the operation or client, such as star symbol 711. In another embodiment, a node that has already been placed on the seabed may have a symbol global to the survey that represents the geographic placement of such a node, such as box symbol 713. In another embodiment, a node that has already been recovered may have a symbol indicating the geographic coordinates that were recorded when the node was retrieved from the seabed, such as circle symbol 715. In one embodiment, survey display 700 is a real-time display that may be accessed at all times by the ROV operator.

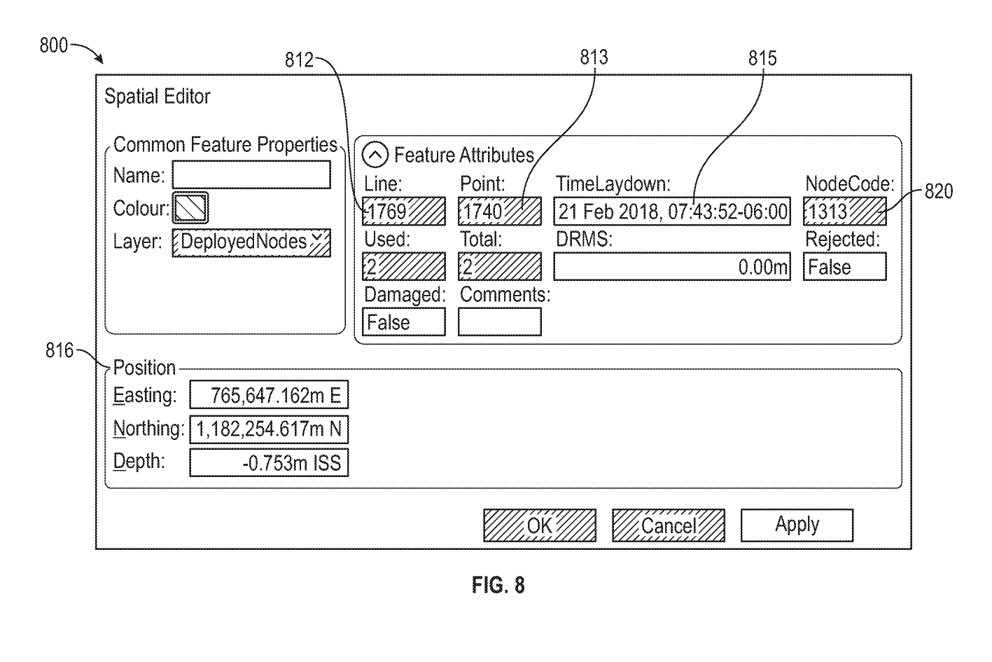

FIG. 8 illustrates one embodiment of node information record 800 for a particular node, such as one that has already been placed on the seabed. Information for a particular node may be viewed by the ROV operator at any time, and is recorded in a database for all of the nodes for a particular survey. In one embodiment, each placed seismic node may be associated with various data points, such as line 812 and point 813, time and data 815 that the node was placed, unique node identification 820, and various geographic positions 816, such as easting, northing, and depth. Other information, geographic, and/or survey observations may be recorded when a node is deployed or retrieved or placed on a node platform.

In one embodiment, substantially all of the subsea operations of the ROV are automated, including any deployment steps, docking procedures with a subsea basket, and movement between various subsea positions.

In one subsea operation, according to the present disclosure, a ROV may be lowered from the surface vessel with a plurality of seismic nodes (on one or more node platforms) and travel to the seabed for the automatic deployment of the seismic nodes at the predetermined positions. The ROV operator may assist in various portions of the deployment process, and at all times the overall tracking and identification of the seismic nodes within the ROV (including node positions and tray positions) is known. As is known in the art, the ROV may travel to the surface vessel or subsea basket to obtain new seismic nodes to deploy on the seabed.

In one subsea operation, according to the present disclosure, a ROV may approach a subsea basket and collect a tray loaded with a plurality of ocean bottom seismic nodes. Within a user interface system of the ROV navigation system, the ROV operator may cycle through the user interface to pick the corresponding tray that the ROV has collected. This generated list may include all available trays that were ordered and delivered to the subsea basket. After selecting a tray (which then determines the unique seismic nodes already loaded on that tray), automated guidance is provided to the ROV to guide it to the placement of the first node from that tray to be deployed on the seabed and/or deployment line. The ROV is then guided to the seabed placement location either through an auto-pilot system of the ROV or by manual override by the pilot.

In one embodiment, a STARFIX navigational system is utilized. As is known in the art, STARFIX is a flexible and scalable marine survey navigation engine offered by FUGRO, and provides high performance positioning systems for ROVs and other subsea activities that uses GPS and other satellite technologies. In some embodiments, known software solutions (such as DEEPWORKS) may be utilized for the 3D simulation, visualization and supervisory control of the surface vessel, underwater vehicle and underwater baskets and cables floating and under tension. DEEPWORKS is a complete mission simulation and visualization environment supporting real engineering and physics, allowing forces, tensions, velocities, sea states, currents, and cables to be modelled for a subsea operation. In combination, STARFIX and DEEPWORKS delivers simultaneous operation and situational awareness over multiple surface and subsea vessels with 4D situational awareness of all assets current and future.

All of the systems and methods disclosed and claimed herein can be made and executed without undue experimentation in light of the present disclosure. While the apparatus and methods of this invention have been described in terms of preferred embodiments, it will be apparent to those of skill in the art that variations may be applied to the methods and in the steps or in the sequence of steps of the method described herein without departing from the concept, spirit and scope of the invention. In addition, modifications may be made to the disclosed apparatus and components may be eliminated or substituted for the components described herein where the same or similar results would be achieved. All such similar substitutes and modifications apparent to those skilled in the art are deemed to be within the spirit, scope, and concept of the invention.

Many other variations in the configurations of the docking system are within the scope of the invention. For example, other holdings devices or platforms besides trays may be used. Multiple ROVs or other subsea baskets may be utilized. Portions of the deployment system may be manually operated and/or fully automated. As another example, other devices or payloads besides autonomous seismic nodes may be loaded onto the deployment basket and ROV skid. As still another example, the underwater vehicle may be any unmanned underwater vehicle (UUV), autonomous underwater vehicle (AUV), remotely operated vehicle (ROV), or even a manned submersible. As still another example, the ROV may dock to any subsea structure, whether stationary or moving, such as subsea equipment located on or near the ocean floor, a subsea vessel, subsea equipment located anywhere between the surface and the seabed, and a lowerable basket or skid. As still another example, a tray may not be used, and instead the seismic nodes are positioned on one or more horizontal rails or bars within the ROV and subsea basket. It is emphasized that the foregoing embodiments are only examples of the very many different structural and material configurations that are possible within the scope of the present invention.

Although the invention(s) is/are described herein with reference to specific embodiments, various modifications and changes can be made without departing from the scope of the present invention(s), as presently set forth in the claims below. Accordingly, the specification and figures are to be regarded in an illustrative rather than a restrictive sense, and all such modifications are intended to be included within the scope of the present invention(s). Any benefits, advantages, or solutions to problems that are described herein with regard to specific embodiments are not intended to be construed as a critical, required, or essential feature or element of any or all the claims.

Unless stated otherwise, terms such as “first” and “second” are used to arbitrarily distinguish between the elements such terms describe. Thus, these terms are not necessarily intended to indicate temporal or other prioritization of such elements. The terms “coupled” or “operably coupled” are defined as connected, although not necessarily directly, and not necessarily mechanically. The terms “a” and “an” are defined as one or more unless stated otherwise. The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system, device, or apparatus that “comprises,” “has,” “includes” or “contains” one or more elements possesses those one or more elements but is not limited to possessing only those one or more elements. Similarly, a method or process that “comprises,” “has,” “includes” or “contains” one or more operations possesses those one or more operations but is not limited to possessing only those one or more operations.

What is claimed is:

1. A method for automatic identification of ocean bottom seismic nodes, comprising automatically identifying a unique identification number for each of a plurality of seismic nodes;
positioning the plurality of seismic nodes on a node platform at a plurality of node positions within the node platform; and
automatically recording each of the unique identification numbers for each of the plurality of node positions.

2. The method of claim 1, further comprising
automatically tracking the position of each of the plurality of seismic nodes within the node platform based on the unique identification number of each of the plurality of seismic nodes.

3. The method of claim 1, further comprising
automatically loading the plurality of seismic nodes on the node platform based on the unique identification number of each of the plurality of seismic nodes.

4. The method of claim 1, further comprising
automatically transferring the plurality of seismic nodes from the node platform based on the unique identification number of each of the plurality of seismic nodes.

5. The method of claim 1, further comprising
selecting one of the plurality of seismic nodes for transfer from the node platform based on the unique identification number of each of the plurality of seismic nodes.

6. The method of claim 1, further comprising
transferring the node platform with the plurality of seismic nodes onto a remotely operated vehicle.

7. The method of claim 1, further comprising
deploying each of the plurality of seismic nodes on the seabed at a predetermined position by a remotely operated vehicle based on the unique identification number of each of the plurality of seismic nodes; and
automatically recording the touchdown position of each of the plurality of seismic nodes.

8. The method of claim 1, wherein the unique identification number comprises a RFID tag or a visible marker on the node.

9. A method for the deployment of a plurality of seismic nodes on or near the seabed, comprising
automatically positioning a remotely operated vehicle proximate to the seabed, wherein the underwater vehicle carries a plurality of seismic nodes, wherein each of the plurality of seismic nodes comprises a unique identification number;
selecting one of the plurality of seismic nodes for deployment on the seabed;
automatically deploying the selected seismic node at a predetermined position on the seabed;
automatically determining a touchdown position of the node on the seabed; and
automatically recording the touchdown position of the node.

10. The method of claim 9, wherein the touchdown position comprises position coordinates, depth, and azimuth of the node.

11. The method of claim 9, further comprising automatically associating the touchdown position of the node with the unique identification number of the node.

12. The method of claim 9, further comprising automatically tracking the position of each of the plurality of seismic nodes within the remotely operated vehicle based on the unique identification number for each of the plurality of seismic nodes.

13. The method of claim 9, wherein the recording step comprises taking a picture of the node on the seabed.

14. The method of claim 9, wherein the positioning step is based on automated guidance from a navigation system.

15. The method of claim 9, wherein the selecting step is based on the unique identification number for each of the plurality of seismic nodes.

16. The method of claim 9, wherein the selecting step comprises selecting one of the plurality of seismic nodes by selecting a unique identification number.

17. A method for the recovery of a plurality of seismic nodes on or near the seabed, comprising
automatically positioning a remotely operated vehicle proximate to a plurality of positions on the seabed, wherein a seismic node is located at each of the plurality of seabed positions, wherein each of the plurality of seismic nodes comprises a unique identification number;
automatically recovering a plurality of seismic nodes from the seabed by the remotely operated vehicle;
selecting one of the plurality of seismic nodes for recovery from the seabed based on a unique identification number of each of the plurality of seismic nodes; and
automatically identifying the unique identification number of each of the plurality of seismic nodes.

18. The method of claim 17, wherein the positioning step is based on automated guidance from a navigation system.

19. The method of claim 17, further comprising automatically tracking the position of each of the plurality of seismic nodes within the remotely operated vehicle.

20. The method of claim 17, further comprising
positioning the plurality of seismic nodes on a node platform within the underwater vehicle at a plurality of node positions within the node platform; and
automatically recording each of the unique identification numbers for each of the plurality of node positions.
